(19) United States
(12) Patent Application Publication
(10) Pub. No.: US 2003/0103725 A1
(43) Pub. Date: Jun. 5, 2003

(54) Packaging methodology for assembly automation for dwdm and oadm modules

(76) Inventor: Jim W. Li, Fremont, CA (US)

Correspondence Address: JOSHUA D. ISENBERG, 204 CASTRO LANE, FREMONT, CA, 94539, US

(21) Appl. No.: 10/007,404

(22) Filed: Dec. 4, 2001

(51) Int. Cl. G02B 6/32; G02B 6/26

(52) U.S. Cl. 385/34; 385/33; 385/39

(57) ABSTRACT

A method for manufacturing an optical device, and an optical apparatus are disclosed. In the manufacturing method an optical component is disposed proximate a collimator lens such that a reflecting portion of the optical component is disposed on a focal plane of the collimator lens. The reflecting portion of the optical component is configured to reflect at least a portion of an optical signal from a launch fiber back towards a receiving fiber that is disposed on the same side of the optical component as the launch fiber. The optical component is passively aligned at an angular orientation with respect to the focal plane of the collimator lens. The apparatus includes an optical component, a collimator lens, and a spacer disposed between the component and the collimator lens. The spacer is configured to fix the distance between a reflecting portion of the optical component and the collimator lens and to passively align the optical component at an angular orientation with respect to the focal plane of the collimator lens. The apparatus and method may be extended to include second collimator lens at a fixed distance from the optical element such that the reflecting portion of the optical component is disposed on a focal plane of the second collimator lens. The reflecting portion may include a filter. The collimator lens may have at least one convex surface. Alternatively, the collimator lens may be a GRIN lens.

### FIELD OF THE INVENTION

This invention generally relates to optical communication systems. More specifically, this invention relates to packaging of components for optical devices such as wavelength division-multiplexing and optical add-drop modules.

### BACKGROUND OF THE INVENTION

Fiber collimators are basic and critical components for efficient light transmission between fibers. Gradient Index (GRIN) lenses are commonly used to collimate light from optical fibers due to easy packaging. Such GRIN lenses often find application in dense wavelength divisional multiplex (DWDM) optical transmission systems and optical add-drop modules (OADM). For different applications such as interleavers and large matrix optical switches, where a long working distance is often required, GRIN lenses may also be employed but the resulting optical device can suffer from excess coupling loss. In addition, for applications such as pump modules in optical amplifiers where high power laser beams are transmitted, concerns have been raised regarding irreversible property changes of the dopants introduced into the GRIN lens as a result of continuous long-term exposure to intense light.

Another type of fiber collimator is sometimes known as a c-lens collimator. A c-lens is a plano-convex lens rod in which the material, the curvature of the convex surface, and the length of the rod can be engineered such that the desired mode field profiles and the location of the beam waist is obtained. As a result, the coupling between fibers for a given working distance is maximized. Examples of c-lenses are designed, manufactured, and distributed by Koncent Communication, Inc. of Fuzhou, China. The c-lens has many advantages, particularly for optical applications that require long working distances. Plano convex lenses such as c-lenses can be produced at much lower costs than GRIN lens. Flexibility in c-lens design for a wide range of applications that may not be feasible with GRIN lens, together with low manufacturing cost makes c-lens a very competitive and attractive candidate for fiber collimators.

While c-lenses have been shown to work better in large-scale optical switches and interleavers, its applications in DWDM and OADM have not been fully explored. At present filter-based DWDM modules and OADMs are commonly made with GRIN lens collimators due to the fact that a GRIN lens has planar surfaces at both front and rear facets. This configuration seems to present some immediate advantages from a packaging standpoint. FIG. 1 shows the trajectory of light carrying WDM signals ₁ and ₂ in a traditional GRIN-lens-based DWDM/OADM unit. A first GRIN lens 105 having 0.23 to 0.25-pitch is typically employed to collimate WDM signals λ₁ and λ₂ from a launching fiber 101. Such a configuration is convenient in assembly process because the beam waist 113 of the collimated beam is located near or at the rear facet of the first GRIN lens 105. As a result, a DWDM filter 110 can be attached directly onto the rear facet. The DWDM filter 110 is usually made of multiple dielectric layers 111 deposited onto a glass substrate 112. The filter 110 intercepts optical signals having wavelength λ₁ and λ₂ from the input fiber at port 101, allowing signal λ₁ to pass through to the output fiber at port 103, and reflecting signal λ₂ back to a second output fiber at port 102 adjacent to the input fiber 101.

In a conventional packaging process, the second GRIN lens 106 is usually attached to a single fiber pigtail 118 inside a glass sleeve 127 to form a single fiber collimator 117. The single fiber collimator 117 is then adjusted along three translational axes, X, Y, Z, and three rotational axes, θₓ, θ_{y}, and θ_{z} to achieve maximum coupling between port 101 and port 103. Alignment in X- and Y-axis is relatively easy because of the relatively large beam size (typical beam diameter at 1/e² intensity is ˜0.4-0.5 mm) and therefore large alignment tolerance. Angular alignment, θₓ and θ_{y}, however, is very difficult and time consuming because of small tolerance as a result of small mode field diameter (˜10 μm) at the fiber input 119. As an illustration, for a GRIN lens with effective focal length f=1.93 mm (SLW1.8, 0.25-pitch), the displacement of the focus beam spot away from the fiber input 119 is Δ=f·α where α is the tilt angle of the second fiber collimator 117. For a as small as 0.1°, the focal beam spot can miss the receiving fiber entrance 119 by Δ=3.4 μm. Consequently the coupling efficiency may drop by as much as 1.9 dB. To achieve a coupling loss less than 0.2 dB, the angle misalignment should be smaller than 0.03°. Such small angle adjustment is impractical in an automated assembling process. The conventional process also raises concerns regarding failure during thermal/humidity cycling after assembly and long-term reliability due to epoxy creeping. Consequently much of the packaging and assembly of optical components is done by hand, which tends to increase costs and reduce yields of useable devices.

Therefore, a need exists in the art of manufacturing and designing the fiber-optic communication system to provide an improved configuration to overcome the difficulties in process automation and in employing c-lenses in DWDM and OADM applications. Furthermore, it is desirable that the new configurations and method of manufacturing can fully utilize the advantageous operational characteristics of the c-lens to provide new and further improved optical devices that are not only cheaper to make but also provide better performance with higher operational reliability.

### SUMMARY OF THE INVENTION

It is therefore an object of the present invention to provide new configurations and methods of manufacture for producing new optical devices, e.g., for DWDM and OADM applications, at lower cost and achieving full alignment automation and better performance by using collimator lenses to resolve the difficulties and limitations discussed above.

The disadvantages associated with the prior art are overcome by embodiments of the present invention directed to a method, a method of manufacturing an optical device implemented with a collimator lens, an optical apparatus and a wavelength division multiplexing (WDM) apparatus.

The method of the manufacturing an optical device may proceed by disposing an optical component proximate a first collimator lens such that a reflecting portion of the optical component is disposed on a focal plane of the first collimator lens. The reflecting portion is configured to reflect at least a portion of an optical signal from a launch fiber back towards a receiving fiber disposed on the same side of the optical component as the launch fiber. The optical component is passively aligned at an angular orientation with respect to an optical axis that is substantially perpendicular to the focal plane of the first collimator lens. The distance between the optical component and the first collimator lens may be fixed by engaging a first surface of an optical component to a first end of a first spacer and engaging the first collimator lens to a second end of the first spacer. The first spacer may have a length selected such that, when it engages the optical component and the first collimator lens, the optical component is disposed on the focal plane of the first collimator lens. A distance between the optical component and a second collimator lens may be fixed such that the reflecting portion of the optical component is disposed on the focal plane of the second collimator lens. The optical component may be passively aligned at an angular orientation with respect to an optical axis that is substantially perpendicular to a focal plane of the second collimator lens. The distance between the optical component and the second collimator lens may be fixed in a similar manner using a second spacer between the optical component and the second collimator lens. The first and/or second collimator lens may include at least one convex surface. A fiber pigtail may be aligned with the optical component by maintaining an alignment of the optical component with respect to the focal plane while moving the fiber pigtail along a direction substantially parallel to the optical axis of the first or second collimator lens for beam focus and moving the fiber pigtail along a direction substantially perpendicular to an optical axis of the first or second collimator lens. A second fiber pigtail may be aligned with the second collimator lens and the optical component in a similar fashion.

The apparatus includes an optical component, a first spacer and a first collimator lens. The optical component includes a reflecting portion that is configured to reflect at least a portion of an optical signal from a launch fiber back towards a receiving fiber disposed on the same side of the optical component as the launch fiber. The first spacer is disposed between the optical component and the first collimator lens. The first spacer has a length selected such that, when it engages the optical component and the first collimator lens, the first surface of the optical component is disposed on the focal plane of the first collimator lens. The first spacer is configured to passively align the optical component at an angular orientation with respect to an optical axis that is substantially perpendicular to a focal plane of the first collimator lens. The apparatus may include a second spacer and a second collimator lens. The second spacer may be disposed between the optical component and the second collimator lens. The second spacer may have a length selected such that, when the second spacer engages the optical component and the second collimator lens, the reflecting portion of the optical component is disposed on a focal plane of the second collimator lens. The second spacer may be configured to passively align the optical component at an angular orientation with respect an optical axis that is substantially perpendicular to the focal plane of the second collimator lens. The apparatus may further include a holding tube that receives the optical component, spacers and collimator lenses.

The reflecting portion of the optical component may include a filter, such as a wavelength division multiplexing (WDM) filter or optical add/drop multiplexer (OADM) filter. The filter may include a thin film disposed on a surface of a glass substrate. A fiber pigtail may be optically aligned with the optical component with the collimator lens disposed between the optical component and the fiber pigtail. The apparatus may also include a second fiber pigtail that is similarly aligned with the second collimator lens and the optical component. The filter may be configured to transmit a certain band or bands of wavelengths while reflecting other wavelengths. Such an apparatus may be used in wavelength division multiplexing (WDM) or an optical add/drop module (OADM). In certain embodiments of the apparatus the optical element is a filter, and the first and second collimator lenses have convex surfaces.

Embodiments of the present invention allow for simpler and more easily automated assembly of optical devices. The simplicity and automation of assembly leads to higher yield and lower cost optical devices.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

FIG. 1 is a cross sectional view of a filter based DWDM unit implemented with a GRIN lens collimator according to a prior art configuration;

FIG. 2 is a cross sectional view of a filter based DWDM unit implemented with a c-lens according to an embodiment of the invention;

FIGS. 3A to 3C are side cross sectional views showing the positions of the beam spots at the focal plane of a c-lens;

FIG. 4 is a diagram showing simulation results of a functional relationship between return coupling loss and the distance d between the filter and the convex facet of a c-lens;

FIGS. 5A to 5C are cross sectional views of two configurations for attaching a filter to a glass (or metal) sleeve for interfacing with a c-lens according to an embodiment of the invention;

FIGS. 6A and 6B are cross sectional views of two configurations for attaching a filter and two spacers inside a holding tube according to embodiments of the invention; and

FIG. 7 is a cross sectional view of a DWDM band-pass filter implemented with c-lenses according to a new configuration according to an embodiment of the invention.

FIGS. 8A and 8B show cross-sectional views of an optical apparatus implemented using GRIN lens collimators according to embodiments of the invention.

FIGS. 9A and 9B show cross-sectional views of optical apparatus implemented using both GRIN lens and c-lens collimators according to embodiments of the invention.

### DETAILED DESCRIPTION OF THE INVENTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention. Like number refer to like elements throughout.

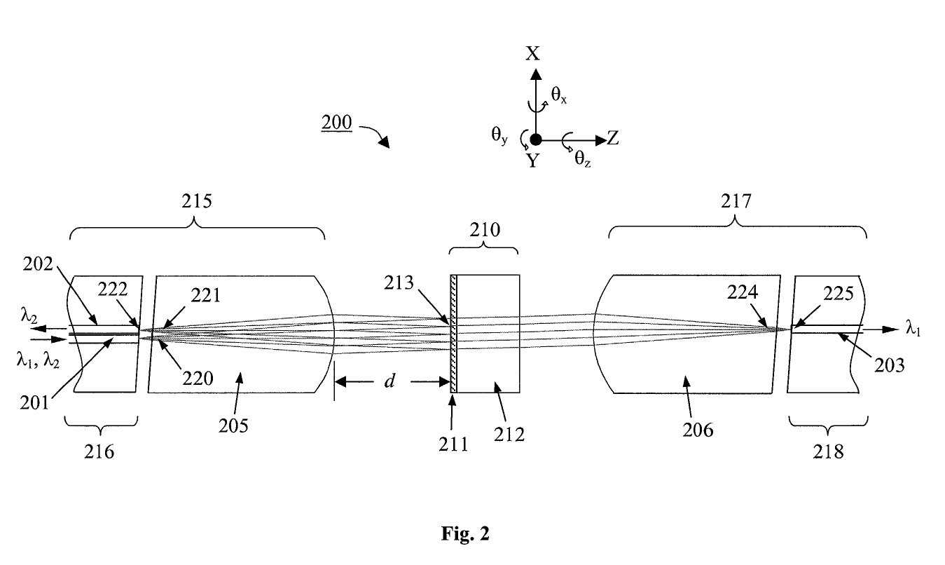

Referring to FIG. 2 for a filter-based DWDM/OADM device implemented with a c-lens as a basic configuration as to be further described below according to improved configuration of this invention. Although FIG. 2 presents an example of an embodiment of the invention as applied to WDM/OADM applications, other embodiments may be devised for applications involving an optical component with a reflecting portion configured to reflect at least a portion of an optical signal from a launch fiber back towards a receiving fiber that is disposed on the same side of the optical component as the launch fiber. The description here provides an example of difficulty as perceived by those of ordinary skill in the art of the DWDM/OADM packaging when implemented with a collimating lens that may be c-lens, a GRIN lens or other types of collimating lenses. As used herein, the term “collimating lens” refers generally to lenses that are capable of focusing parallel light to a narrow beam waist and vice versa. FIG. 2A shows a filter-based DWDM/OADM unit 200 that includes a dual-fiber collimator 215, an optical component such as a DWDM filter 210, and a single-fiber collimator 217. The DWDM filter 210 may include one or more dielectric layers 211 deposited on a glass substrate 212. Alternatively, the dielectric layers 211 may be one or more partially reflecting layers. Such partially reflecting layers may reflect a portion of an incident signal independent of wavelength, alternatively, the reflecting layers may reflect optical signals of one polarization while transmitting signals having a complementary polarization. The dual-fiber collimator further includes a dual-fiber pigtail 216 optically coupled to a first collimating lens 205. Similarly the single-fiber collimator 217 includes a single-fiber pigtail 218 optically coupled to a second collimating lens 206.

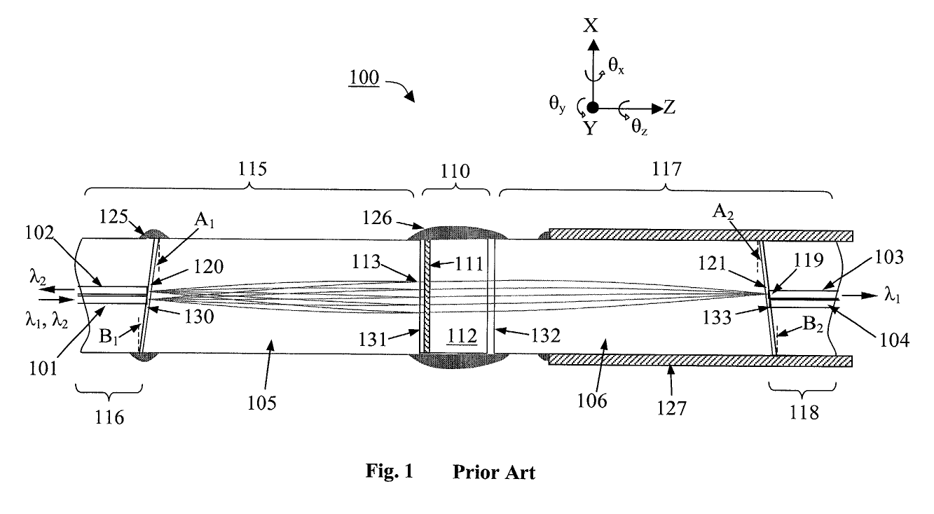

Application of a lens having a convex surface, such as a c-lens, as a collimator in DWDM/OADM modules is generally not favorably considered by the prior art. As shown in FIG. 2, the rear facet of the c-lens is curved and the beam waist 213 is not located at the lens facet but rather at a distance d from the lens. Therefore means of holding the filter 210 and aligning the filter 210 to the collimated beam at the beam waist 213 are required. Comparing FIG. 1 with FIG. 2, the use of GRIN lens over c-lens seems to present more convenient packaging and assembling processes since the filter can be attached directly to the flat face of the GRIN lens. However a standard c-lens typically costs about half as much as a standard GRIN lens and can, therefore, lower the production costs of DWDM devices and OADM modules. Furthermore, the inventors have discovered that there are advantageous optical properties associated with c-lenses that actually simplify the alignment of the filter 210 with respect to the c-lens.

Several alignment steps are required to minimize insertion loss. For light coupling from port 201 to port 202, the alignment is carried out by first launching light into port 201. Adjustment is then made to the location of filter 210 to the focus plane of lens 205 as well as filter's lateral position and tilt angle until maximum return signal is detected at port 202. For light traveling from port 201 to port 203, alignment is carried out by adjusting the position of the single-fiber collimator 217 in three dimensions, i.e., (X, Y, Z). Meanwhile, the tilt angle is adjusted to achieve maximum output at port 203. The most stringent alignment in this DWDM unit is the angular alignment (θₓ, θ_{y}) of single-fiber collimator 217 as previously discussed, as well as angular alignment (θₓ, θ_{y}) of the DWDM filter 210. As an illustration, for a collimating lens with an effective focal length of 2.0 mm, when the norm of the filter's surface is tilted by only 0.1° with respect to the optical axis, the return beam 221 at the end face of the receiving fiber 222 is shifted along X-axis by 3.5 μm. The mode-field overlap calculation shows that the coupling loss due to this shift is 2.0 dB for a 1/e² mode field diameter of 10.2 μm at the fiber facet. The angular misalignment of the DWDM filter 210 needed to be controlled to within ±0.0150° if coupling loss is to be kept below 0.2 dB. Again, this tight tolerance not only requires precision active alignment, a time-consuming process, but also imposes tremendous challenge in maintaining the alignment during epoxy curing.

Tilting the filter 210 introduces two additional undesirable effects. The first effect is an increase in wave-front distortion, which directly affects coupling efficiency. The second effect is the wavelength shift of the signal channels. DWDM filters are typically designed and fabricated for specific incidence angles because the center transmission and reflection wavelength depends on the incidence angle. As the filter is tilted, the central wavelength is shifted. The amount of wavelength shift versus the incidence angle may be determined by the following equation,

Δλ=λ₀(\sqrt{1 −a(sin φ)²}−1),

where λ₀ is the wavelength at normal incidence, φ is the incidence angle, and a is a parameter governed by the effective indexes of the coating layers. By way of example, and without loss of generality, for most DWDM filters, a is approximately equal to 0.4. Thus in the fiber's transmission wavelength range, the center wavelength of the pass-band may be shifted by as much as 0.1 nm when filter is tilted by 1°.

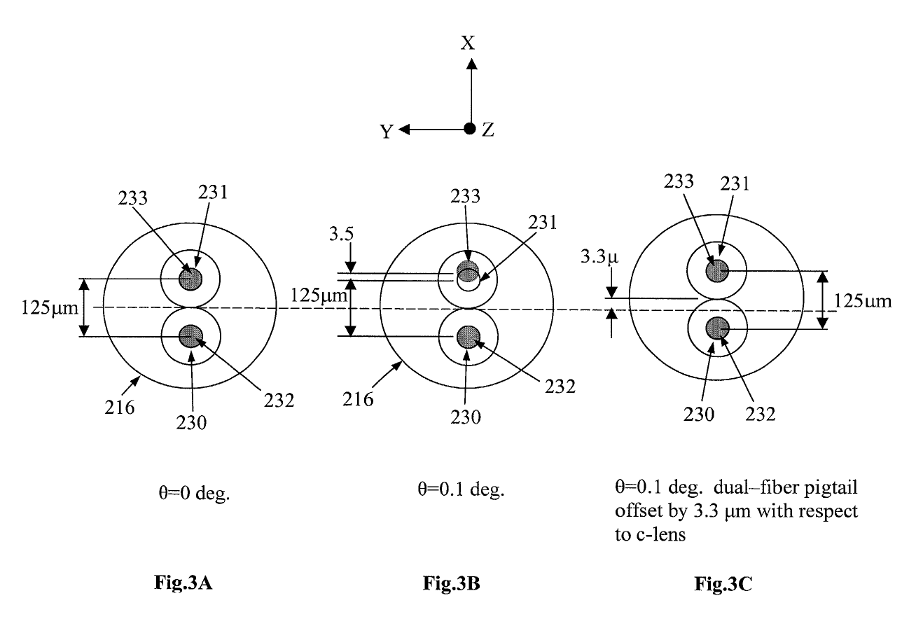

Referring to FIGS. 3A to 3C for an effective procedure to overcome the difficulties described in FIG. 2. According to an improved procedure to be described in this invention, the returning beam alignment, correction of wave-front aberration, and correction of central wavelength shift can be achieved simultaneously by laterally adjusting a displacement of the fiber pigtail 216 and 218 with respect to the collimating lens 205 and 206, respectively. FIG. 3 shows the cross-section of the dual-fiber pigtail 216 (dimensions not to scale). The spacing between the core 230 of the launching fiber 201 and the core 231 of the receiving fiber 202 is 125 μm, and the effective focal length of the collimator is 2.0 mm. When filter is perfectly aligned the return beam spot 233 falls exactly onto the fiber core 231, as shown in FIG. 3A. Under a condition that the filter is tilted by an angle of 0.1° the return beam spot 233 is shifted upward, missing the receiving fiber core 231 by 3.5 μm as shown in FIG. 3B. Specific analyses have been performed with a ray-tracing simulation. The simulation results show that a displacement of the dual-fiber pigtail 216 with respect to lens 205 along the X-axis by 3.3 μm can bring the launching beam spot 232 and the return beam spot 233 back to 125 μm spacing as shown in FIG. 3C. Consequently, the mode field of the return beam 233 is lined up with the fiber core 231. This is a general property of any collimating lens and is attributed to the fact that the converging power is greater for rays further away from the optical axis. In other words, the rays further away from the optical axis are bent more than the rays closer to the optical axis. The above analysis indicates that stringent angular alignment of the filter can be replaced by a more convenient linear displacement alignment by adjusting a linear displacement between the dual-fiber pigtail and collimator.

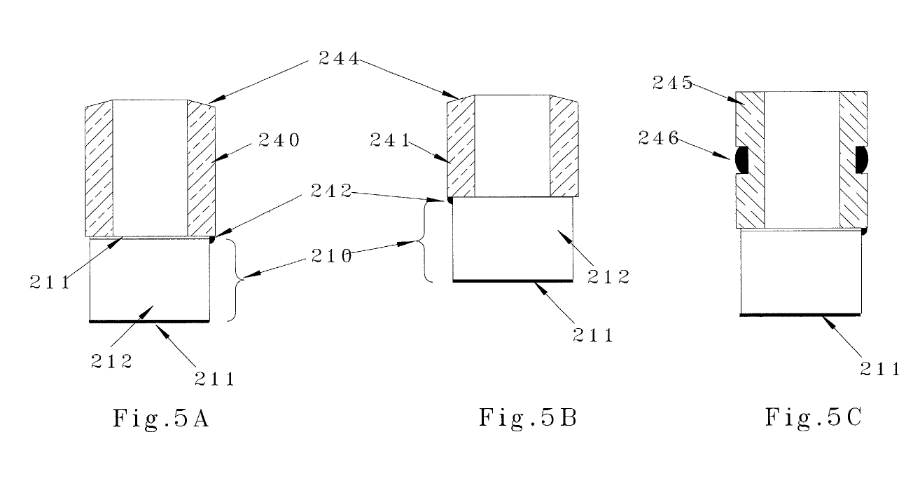

According to FIGS. 3B and 3C, a first embodiment of the present invention discloses a method for aligning a return beam 221 to a return-beam fiber 202 of a dual-fiber pigtail 205, and a forward beam 224 to a forward-beam fiber 203, as shown in FIG. 2. The method includes the steps of A) projecting an incidence beam 220 from a launch optical fiber 201 of the dual-fiber pigtail through a c-lens 205. B) Placing a filter 210 on a focal plane of the c-lens 205 for reflecting a return beam 221 back to the return-beam fiber 202 of the dual-fiber pigtail and transmitting a forward beam 224 to the forward-beam fiber 203. C) keeping the filter 210 at a fixed orientation at the focal plane of the c-lens while moving the dual-fiber pigtail 216 along a direction substantially perpendicular to an optical axis of the c-lens, e.g., in X-Y-plane, for receiving the return-beam 221 into the return-beam optical fiber 202. And, (D) moving the single-fiber pigtail 218 along a direction substantially perpendicular to an optical axis of the c-lens 206, e.g., in X-Y-plane, for receiving the forward-beam 224 into the forward-beam optical fiber 203. According to FIGS. 5A or 5B below, the step of placing a filter on a focal plane of the c-lens may be accomplished by engaging, e.g., attaching, the filter to a first end of a spacer having a pre-determined length. And, placing the c-lens with a convex surface adopted into a second end of the spacer whereby the filter is disposed on the focal plane of the c-lens.

The results of ray tracing simulations of the above method are shown in Table 1 below.

TABLE 1
Summary of Ray-Trace Simulation Analyses with C-Lens

| Filter | Dual- | Strehl Ratio | Incidence angle | Back |
|---|---|---|---|---|
| tilt | fiber | at receiving | w.r.t. filter | Coupling |
| angle | offset in | fiber after | surface normal | Loss after |
| θ (deg.) | X-axis (μm) | offset | after offset (deg.) | offset (dB) |
| 1.0 | 33.1 | 0.980 | 1.884 | −0.12 |
| 0.75 | 24.8 | 0.984 | 1.884 | −0.12 |
| 0.5 | 16.5 | 0.987 | 1.885 | −0.11 |
| 0.25 | 8.2 | 0.989 | 1.885 | −0.10 |
| 0 | 0 | 0.989 | 1.883 | −0.10 |
| −0.25 | −8.3 | 0.990 | 1.884 | −0.10 |
| −0.5 | −16.5 | 0.988 | 1.883 | −0.10 |
| −.75 | −24.8 | 0.986 | 1.885 | −0.10 |
| −1.0 | −33.1 | 0.983 | 1.887 | −0.11 |

As an example, Column 1 of Table 1 shows filter's misalignment errors from −1° to 1°. Here the plus sign + is assigned to clockwise tilt of filter 210 as shown in FIG. 2; the minus sign − is assigned to counter-clockwise tilt. Column 2 shows the corresponding distances that the dual-fiber collimator 216 should move to align the receiving fiber core 231 to the return beam spot 233. A positive sign, i.e., +, represents a displacement along X-axis, a negative sign, i.e., −, represents displacement along −X-axis.

By applying a linear displacement to the collimator, the problem of additional wave-front distortion with a direct impact on coupling efficiency is significantly reduced. Wave front distortion may be measured by a quantity known as the Strehl ratio. In an aberration-free optical system, the Strehl ratio is 1. For the present c-lens, the Strehl ratio of the focused beam spot at the receiving fiber is decreased from 0.989 at _{y}=0° to 0.916 at _{y}=1.0°. The key contribution to the increase in wave-front aberration is the third-order astigmatism, followed by slight increase in spherical aberration. The ray trace simulation shows that displacing the dual-fiber pigtail by a distance listed in Column 2 of Table 1 not only restores the spacing between the launching beam 232 and the return beam 233, but also corrects for astigmatism introduced by the tilting of the filter 210. Column 3 shows the Strehl ratio of the return beam after correction. Furthermore, the problems associated with a shift of central wavelength are also resolved. The ray-trace results show that after offsetting the dual-fiber pigtail 216 by a distance listed in Column 2 relative to the collimating lens 205, the incidence angle, and therefore the center wavelength, is essentially unchanged.

Column 5 in Table 1 shows the back-coupling losses after pigtail offset. As can be seen, the coupling losses are sufficiently small for filter misalignment from −1° to 1°. These results are of significance to the packaging process because they indicate that there is no need to precisely adjust the filter's angle alignment whose tolerance is difficult to achieve anywhere. The insertion loss of a DWDM due to filter's angle misalignment can be almost completely corrected for by simply adjusting the pigtail laterally, a process that is much easier, more reliable and more easily automated than angular alignment.

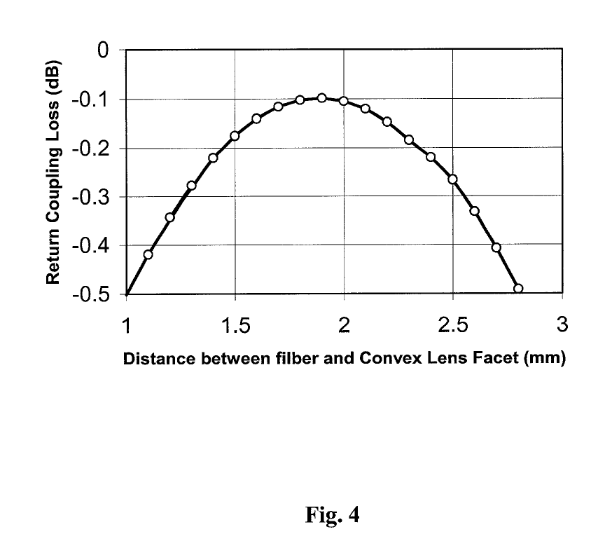

For the purpose of assembling a DWDM/OADM module, in addition to adjustment of incidence angle to the filter, the filter's location along the optical axis also needs to be adjusted for minimum return loss between port 201 and port 202. According to the simulation results shown in FIG. 4, the coupling losses between port 201 and port 202 is not sensitive to the filter's distance d from the lens. In other words, the axial positional tolerance of the filter can be as large as ±0.5 mm or more.

With the above analysis of alignment tolerances and new assembly techniques, new embodiments of DWDM/OADM using c-collimating lens assembled with new methods are further described below. Referring to FIGS. 5A and 5B, two optional novel configurations are shown for providing an interface between a flat optical filter and a c-lens that has a curved surface. A DWDM filter 210 is formed with dielectric films 211 coated on a light transmitting substrate 212. The dielectric films serve as a reflecting portion that reflects at least a portion of an optical signal from the launch fiber 201, back towards a receiving fiber, e.g. fiber 202, that is disposed on the same side of the filter 210 as the launch fiber.

For the purpose of interfacing with a lens having a curved surface, e.g., a c-lens, the DWDM filter 210 is engaged to a glass sleeve 240 or 241. As shown in FIG. 5A, the coated filter surface 211 may be directly attached to the glass sleeve 240 by a heat-curing epoxy 242 such as 353ND from Epoxy Technology of Billerica, Mass. While in FIG. 5B, the coated filter surface 211 is disposed away from the glass sleeve 241 while the bottom surface of the substrate 212 is attached to the glass sleeve 241, e.g., via a heat curing epoxy 242. The glass sleeves 240 and 241 are implemented as spacers to dispose an optical component, such as a collimator lens, with a curved surface at a predefined distance from another optical component, such as a filter attached to the glass sleeve, that has a flat surface. The glass sleeves 240, 241 are cut to predetermined lengths within ±0.5 mm tolerance. The angular orientation between the sidewall of the sleeve and the end face, which is in contact with the filter 210, is controlled to within ±1.0° and more preferably to within ±0.5° relative to an axis perpendicular to the surface of the filter 210. The opposite end face may be cut with a chamfer 244 to allow easy dispensing of epoxy. Another option is to use metallic materials, such as Kovar, as spacers, with material's temperature coefficient of expansion similar to the glass. In this case, a groove can be cut on the outer wall of the sleeve where epoxy 246 is dispensed, as shown in FIG. 5C.

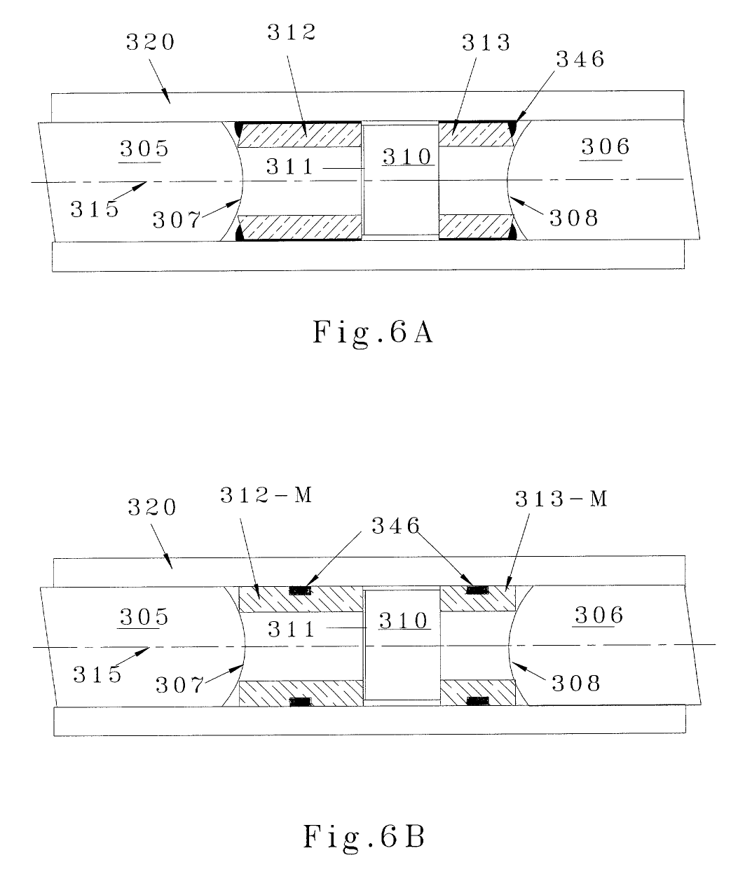

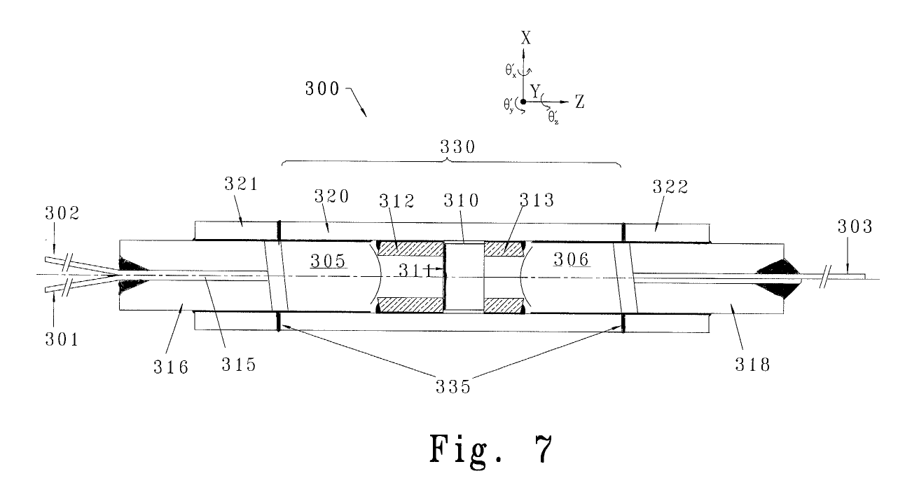

FIGS. 6A-6B and FIG. 7 depict further examples of embodiments of optical apparatus that can be manufactured in accordance with the principles outlined above with respect to FIGS. 2, 3A-5C. With these basic interfacing configurations, an optical component such as a filter 310 and two spacers, e.g., glass sleeves 312 and 313 (or metal sleeves 312-M and 313-M), are inserted into a holding tube 320 such as a third glass sleeve. A filter 310 is disposed between the two spacers 312, 313 (or 312-M, 313-M) as shown in FIGS. 6A-6B. The filter 310 may be of a type that transmits optical signals having wavelengths in a certain band or bands and reflects optical signals having other wavelengths. Such filters may be used, e.g., for WDM or OADM. The filter 310 includes a reflecting portion such as a filter film 311 disposed on light transmitting substrate. The filter film 311 is configured to reflect at least a portion of an optical signal from a launch fiber 301 back towards a receiving fiber 302 that is disposed on the same side of the filter 310 as the launch fiber 301. The spacers 312, 313 (or 312-M, 313-M) and filter 310 are fixed to the holding tube 320, e.g., with heat-curing epoxy 346,. Then two c-lenses 305 and 306 are inserted with convex surfaces 307, 308 placed against the glass sleeves 312 and 313 respectively, as shown in FIG. 6A, or metal sleeves 312-M, 313-M, as shown in FIG. 6B, and with portions of the convex surfaces 307, 308 facing the openings in the glass sleeves 312 and 313 (or metal sleeve 312-M, and 313-M). The glass sleeves 312, 313, and metal sleeves 312-M, 313-M serve as spacers for fixing the distances between the c-lenses 305 and 306 and the DWDM filter 310 such that the filter film 311 is located at the focal planes of lenses 305 and 306. Furthermore, the sleeves 312, 313 or 312-M, 313-M may be configured to passively align the filter film 311 at an angular orientation with respect to an axis 315 that is substantially perpendicular to the focal planes of the c-lenses 305, 306. For example, by suitable engineering of the dimensions of the filter 310, sleeves 312, 313, holding tube 320, and c-lenses 305, 306, the filter film 311 may be passively angularly aligned perpendicular to the axis 315 of the c-lenses 305, 306 within a tolerance of about ±0.5°. For example, the sleeves, 312 and 313 may be manufactured such that the end faces that engage the filter 310 are within ±0.5° of being perpendicular to the axis 315 to passively angularly align the filter 310. Furthermore, the outside diameters of the sleeves 312, 313 (or 312-M, 313-M) and the inside diameter of the holding tube 320 may be chosen such that the sleeves 312, 313 (or 312-M, 313-M) press fit into the holding tube 320. By way of example, a press fit may be sufficiently tight that the sleeves 312, 313 (or 312-M, 313-M) do not fall out of the holding tube 320 when the holding tube is vertically oriented. Preferably, the c-lenses 305, 306 may also be configured to press fit into the holding tube 320. Such passive alignment greatly facilitates automated assembly of components of the type shown in FIGS. 2, 6A-6B.

Referring to in FIG. 7, a dual-fiber pigtail 316 and a single fiber pigtail 318 may be inserted into glass sleeves 321 and 322 respectively. Then the single-fiber pigtail 318 and the dual-fiber pigtail 316 are adjusted in X-, Y-, and Z-axis, as well as pitch θ′_{y} (rotation around Y-axis), yaw θ′ₓ (rotation around X-axis), and roll θ′_{z} (rotation around Z-axis) until minimum insertion losses between ports 301 and 302, and between ports 301 and 303 are detected. The glass sleeve 321 and 322 are slid towards glass sleeve 320 until their end surfaces are in contact with the holding tube 320. A heat curing epoxy 335 may be dispensed at the interface between the glass sleeves 321, 322 and the holding tube 320. The epoxy 335 may be uniformly distributed in the gap between c-lenses 305, 306 and the inner wall of glass sleeve 320, and between pigtails 316, 318 and the inner walls of glass sleeves 321 and 322. The epoxy 335 may then be cured at an appropriate temperature before alignment fixtures are removed. From FIG. 7, it is noted that the air gap between the end face of the c-lenses 305 and 306 and the pigtails 316 and 318 can be properly designed so that epoxy will not diffuse into the optical path area.

There is a fundamental difference in angle alignment θ′ₓ, θ′_{y} for the pigtails 316, 318 shown in FIG. 7 and angle alignment θₓ, θ_{y} for the collimators 215, 217 and filter 210 as previously discussed in reference to FIG. 2. While adjustment of θₓ θ_{y} suffers from extremely small tolerance, adjustment of θ′ₓ, θ′_{y} enjoys large tolerable error. As an illustration, if the single-fiber pigtail 318 is misaligned by ±0.5° with respect to the collimating lens 306, the coupling loss is increased by only ˜0.04 dB. For dual-fiber pigtail 316 tilting along θ′_{y}-axis, the return beam spot 233 in FIG. 3 will shift away from the receiving fiber core 231 resulting in loss of optimum coupling. Again, by displacing dual-fiber pigtail 316 with respect to c-lens 305 substantially parallel to the X-Y-plane, the coupling between the launching fiber 301 and the receiving fiber 302 can be brought back to the optimum value. As an example, for a tilt angle of θ′_{y}=0.5° between dual-fiber pigtail 316 and c-lens/filter assembly 330, fiber pigtail 316 only needs to move ˜2 μm along the X-axis to restore optimum coupling. Therefore with alignment tolerance as large as ±0.5°, angular alignment of pigtails 316 and 318 could be a passive process with mechanical fixtures to define angle θ′ₓ, θ′_{y} to within ±0.5°. As a result, alignment of single- and dual-fiber pigtail to c-lens/filter assembly can be carried out in only three translational axes and no active angle adjustment is needed in θ′ₓ and θ′_{y}. Elimination of active angle alignment tremendously improves the feasibility and simplicity of assembling automation. The burden imposed on manufacture to precisely align the light path among collimators is therefore significantly relieved when the new technique of embodiments of this invention is employed. A comparable prior art DWDM unit implemented with GRIN lenses would require angular misalignment smaller than 0.03° to achieve a coupling loss less than 0.2 dB. As shown in Table 1, by contrast, a coupling loss of less than 0.2 dB is easily achieved even for angular misalignment as large as 1.0° in a DWDM unit implemented with c-lenses of the types shown in FIGS. 2, 6A, 6B and 7.

Although fiber pigtails may be passively aligned in the θ′ₓ, θ′_{y} directions (pitch and yaw), active angular alignment may be desirable with respect to rotation in the θ′_{z} direction about the axis 315 (roll). Such active alignment, which is a form of motion in the X-Y plane, is desirable, for example, to ensure that the maximum amount of return signal couples from the launch fiber 301 to the receiving fiber 302. Such rotational alignment may be easily automated, particularly where the parts being aligned exhibit some symmetry with respect to the axis 315.

Unlike traditional DWDM process where GRIN lenses and pigtails are held by one piece of glass sleeve, here glass sleeve 321 and 322 are free from Glass sleeve 320, thus the epoxies inside the glass sleeve 321 and 322 are allowed to diffuse uniformly into the gaps between glass sleeve 321 and dual-fiber pigtail 316, and between glass sleeve 322 and single-fiber pigtail 318. Thermal stability of a DWDM unit such as that shown in FIGS. 6A, 6B and 7 may be considerably improved by the uniform and isotropic distribution of epoxy during curing process. Also, unlike the situation with the use of GRIN lens where the filter is pressed against the facet of the GRIN lens, the area of the filter that intercepts light is free from any contact. Thus stress and ripples associated with the uneven surface of the GRIN lens may be eliminated. When the filter is attached with the filter side facing away from the c-lens as shown in FIG. 5B, the transmission characteristics of the filter are expected to be superior in terms of temperature stability because the filter side of the substrate material is free to expand and contract, which could result in counter balancing of the filter refractive index variation with temperature such that the filter performance is insensitive to temperature variations.

The alignment and packaging process described above may be applicable for GRIN lenses-based DWDM/OADM if a 0.22˜0.23-pitch GRIN lenses are employed to guarantee sufficient wide gaps between pigtails and GRIN lenses, and if the wedge angle A₂ of the second GRIN lens 106 or the wedge angle B₂ of the second pigtail 118 are properly chosen. Referring now to FIG. 1, as previously mentioned, the beam waist 113 of the launching beam is located in the vicinity of the end facet 131 of the first GRIN lens 105. For the second GRIN lens 106, the beam waist is ˜1.2-1.5 mm away from its facet 132 due to finite filter thickness and the gaps between filter and GRIN lenses. Thus the beam arriving at the entrance 119 of fiber 103 will travel at an angle (˜0.7°-1°) with respect to the optical axis of the fiber 103. It is often found in practice that pigtail 118 needs to be tilted accordingly to catch the maximum amount of light. This configuration not only creates a device that is physically bent but also requires angular alignment during assembly. To avoid beam bending at the output of the second GRIN lens 106, the end face 121 of the second GRIN lens 106, or the end face of the second pigtail 118 may be wedged at an appropriate angle so that the beam becomes straight after diffraction at the wedged surface of the receiving fiber 103. As an illustration, if the wedge angle A₁ for the first GRIN lens 105 and the wedge angle B₁ for the first pigtail 116 are chosen at 8°, then the second GRIN lens 106 and the second pigtail 118 should be polished either at angle A₂˜5.2 and B₂˜8°, or A₂˜8°0 and B₂˜11.3°, respectively. The return loss is better with A₂=8° and B₂=11.3°. Although the cost of the GRIN lens or pigtail with un-conventional wedge angle may be higher, savings resulting from automation of the alignment process may offset this additional cost.

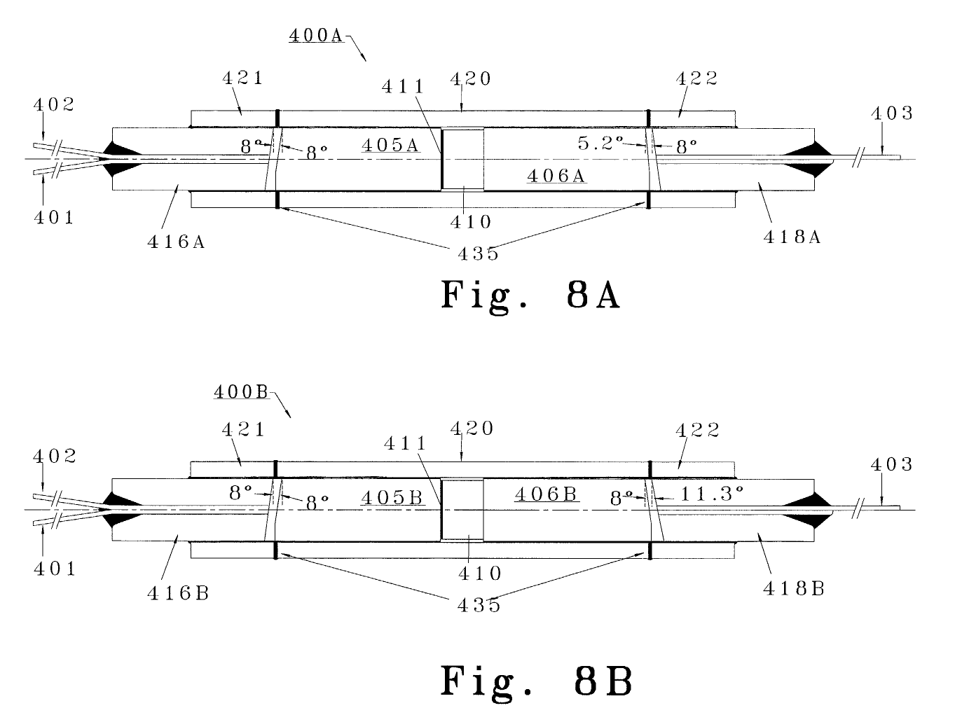

FIGS. 8A and 8B show embodiments of an optical apparatus 400 implemented using GRIN lens collimators. In FIG. 8A, the wedge angles for pigtails 416, 418A are substantially the same (˜8°) but the wedges of the GRIN lenses 405, 406A are different (˜8° and ˜5.2°, respectively). In FIG. 8B, the wedge angles for the GRIN lenses 405, 406B are substantially the same (˜8°) but the wedge angles of the pigtails 415, 418B are different (˜8° and ˜11.3°, respectively). The different wedge angles on the pigtail 418A, 418B and GRIN lens 406A, 406B refract optical signals traveling between the GRINS lens and the pigtail such that the signal follows a path in the fiber pigtail that is substantially parallel to an optical axis of a receiving fiber of the fiber pigtail 403. An optical component such as a filter 410 may include a reflecting portion such as a filter film 411 disposed on light transmitting substrate. The filter 410 may be attached onto the flat end face of the first GRIN lens 405 with the filter film 411 adjacent the end face. Then the filter 410, the first GRIN lens 405, and the second GRIN lens 406 are inserted into a unitary holding tube 420. The single-fiber pigtail 418 and the dual-fiber pigtail 416 are aligned to the filter 410 until minimum insert losses between port 401 and 402, and between 401 and 403, are achieved. The glass sleeves 421 and 422 are slid towards the holding tube 420 until their end surfaces are in contact with the holding tube 420. To facilitate assembly, the GRIN lenses 405, 406A, 406B may include surfaces having portions P that have been polished such that they are parallel to the end faces of the holding tube 420. The fiber pigtails 416, 418A, 418B may also optionally include such flat portions. A heat curing epoxy 435 may be dispensed at the interface between the glass sleeves 421, 422 and the holding tube 420. The epoxy 435 may be uniformly distributed in the gap between GRIN lenses 405, 406 and the inner walls of the holding tubes 420, between pigtails 416A, 416B and the inner walls of glass sleeves 421, and between pigtail 418A, 418B and the inner walls of glass sleeves 422. Finally the alignment fixtures may be removed after epoxy 435 is completely cured at an appropriate temperature.

Embodiments of the present invention of alignment process can be implemented with other 3-port and 4-port optical devices where collimated beams are coupled among ports. Such devices include isolators, circulators, interleavers, switches, attenuators, and optical filters.

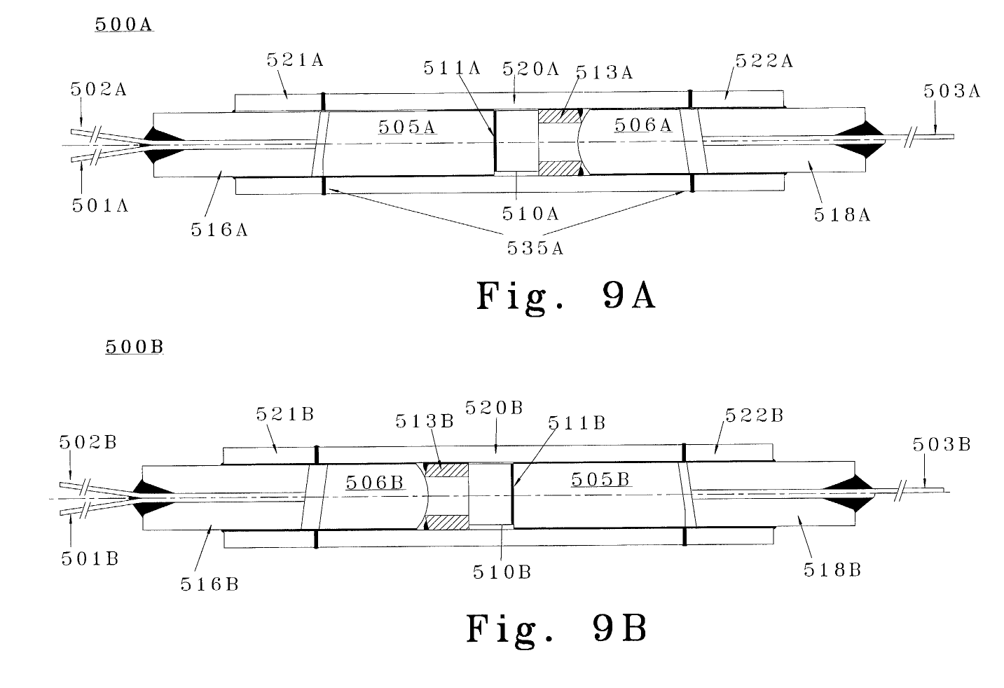

Embodiments of the present invention include the possibility that both GRIN lens collimators and c-lens collimators may be used together. By way of example, FIG. 9A shows an embodiment of an optical apparatus 500A implemented using both a GRIN lens collimator and a c-lens collimator. In the apparatus 500A a GRIN lens 505A is disposed between a dual-fiber pigtail 516A and an optical element such as a WDM filter 510A having a thin filter film 511A. A C-lens 506A is disposed between WDM filter 510A and single-fiber pigtail 518A, with spacer 513A engaged in between filter 510A and c-lens 506A. The filter 510A may be attached directly onto the flat end face of the first GRIN lens 505A using heat-curing epoxy. The focal properties of the collimator lenses 505A, 506A and the thickness of the filter 510A and spacer 513A are such that the thin filter film 511A is disposed on a focal plane the GRIN lens 505A and a focal plane of the c-lens 506A. A holding tube 520A is employed to house filter 510A, GRIN lens 505A, spacer 513A, and c-lens 506A. The single-fiber pigtail 518A and the dual-fiber pigtail 516A are aligned to the filter 510A until minimum insertion losses between port 501A and 502A, and between port 501A and 503A, are achieved. Then glass sleeves 521A and 522A are slid towards the holding tube 520A until their end surfaces are in contact with the holding tube 520A. A heat curing epoxy 535A may be dispensed at the interface between the glass sleeves 521A, 522A and the holding tube 520A. The epoxy 535A may be uniformly distributed in the gap between the inner walls of the holding tubes 520A and the two collimating lenses 505A, 506A, between pigtail 516A and the inner walls of glass sleeves 521A, and between pigtail 518A and the inner walls of glass sleeve 522A. The various components of the apparatus 500A may be held in place with suitable alignment fixtures while the epoxy 535A cures. The alignment fixtures may be removed after epoxy 535A is completely cured at an appropriate temperature.

It is possible to reverse the roles of the GRIN lens and c-lens in an apparatus of the type shown in FIG. 9A.. By way of example, FIG. 9B shows an embodiment of an optical apparatus 500B wherein a c-lens 506B is disposed between dual-fiber pigtail 516B and an optical element e.g., a WDM filter 510B with a thin filter film 511B. A spacer 513B is engaged in between the filter 510AB and the c-lens 506B. A GRIN lens 505B is disposed between the WDM filter 510B and a single-fiber pigtail 518B.. The filter 510B may be attached directly onto the flat end face of the GRIN lens 505B using heat-curing epoxy. The focal properties of the collimator lenses 505B, 506B and the thickness of the filter 510B and spacer 513B are such that the thin filter film 511B is disposed on a focal plane the GRIN lens 505B and a focal plane of the c-lens 506B. The GRIN lens 505B, c-lens 506B, spacer 53B and filter 510B may be housed in a holding tube 520B in a manner similar to that described above with respect to FIG. 9A. The pigtails 516B, 518B may be disposed in sleeves 521B, 522B respectively. The fiber pigtails 518B, 516B may be aligned to the filter 510B until minimum insertion losses are achieved between port 501B and 502B, and between port 501B and 503B. Then glass sleeves 521B, 522B may be slid towards the holding tube 520B until their end surfaces are in contact with the holding tube 520B. A heat curing epoxy 535B may be dispensed at the interface between the glass sleeves 521B, 522B and the holding tube 520A. The epoxy 535B may also be used to secure the collimating lenses 505B, 506B to the holding tube 520B and to secure the pigtails 516B, 518B to the sleeves 521B, 522B in a manner similar to that described above with respect to FIG. 9A.

Although the present invention has been described in terms of the various embodiments, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. A method of manufacturing an optical device, comprising:
positioning an optical component proximate a first collimator lens such that a reflecting portion of the optical component is disposed on a focal plane of the first collimator lens;
passively aligning the reflecting portion of the optical component at an angular orientation with respect to an optical axis that is substantially perpendicular to the focal plane of the first collimator lens,
wherein the reflecting portion of the optical component is configured to reflect at least a portion of an optical signal from a launch fiber back towards a receiving fiber that is disposed on the same side of the optical component as the launch fiber.

2. The method of claim 1 wherein the step of fixing the distance between the optical component and the first collimator lens includes engaging a first surface of an optical component to a first end of a first spacer and engaging the first collimator lens to a second end of the first spacer, wherein the first spacer has a length selected such that, when the first spacer engages the optical component and the second collimator lens, the first surface of the optical component is disposed on the focal plane of the first collimator lens.

3. The method of claim 1, wherein the first collimator lens includes at least one convex surface.

4. The method of claim 1, wherein the first collimator lens is a GRIN lens.

5. The method of claim 1 further comprising:
attaching a first spacer to the optical component;
inserting the optical component, the first spacer and the first collimator lens into a holding tube;
keeping the optical component engaged to the spacer and the spacer engaged to the collimator lens; and
fixing the optical component, spacer and first collimator lens with respect to the holding tube.

6. The method of claim 5, further comprising:
inserting a second spacer and the second collimator lens into the holding tube;
engaging the second spacer to a second surface of the optical component;
engaging the second collimator lens to the second spacer; and
fixing the second spacer and second collimator lens with respect to the holding tube.

7. The method of claim 1 wherein the step of passively aligning the reflecting portion includes aligning the reflecting portion of the optical component within a tolerance of about ±1.0° with respect to the optical axis that is substantially perpendicular to the focal plane of the first collimator lens.

8. The method of claim 1, further comprising:
aligning a first fiber pigtail to the optical component; and
fixing a position of the fiber pigtail with respect to the collimator lens.

9. The method of claim 8 wherein the first fiber pigtail is aligned by maintaining an alignment of the optical component with respect to the focal plane while moving the first fiber pigtail along a direction substantially perpendicular to an optical axis of the collimator lens and moving the first pigtail along a direction substantially parallel to the optical axis of the collimator lens.

10. The method of claim 8, wherein the first fiber pigtail is a dual fiber pigtail.

11. The method of claim 10, wherein the first fiber pigtail is aligned to the optical component by:
projecting an incident beam from a launch optical-fiber of the dual-fiber pigtail through the first collimator lens;
reflecting a return beam back from the optical component to a return-beam fiber of the dual-fiber pigtail; and
while maintaining an alignment of the optical component with respect to the focal plane, moving the dual-fiber pigtail along a direction substantially parallel to the optical axis of the first collimator lens for beam focus and moving the dual-fiber pigtail along a direction substantially perpendicular to an optical axis of the first collimator lens to adjust an optical coupling of the return-beam into the return-beam optical fiber.

12. The method of claim 11 further comprising fixing a position of the dual fiber pigtail with respect to the first collimator lens.

13. The method of claim 8, further comprising:
positioning a second collimator lens proximate the optical component such that the optical component is disposed between the first and second collimator lenses;
passively aligning the optical component at an angular orientation with respect to the focal plane of the second collimator lens,
aligning a second fiber pigtail to the optical component; and
fixing a position of the second dual fiber collimator with respect to the second collimator lens.

14. The method of claim 13, wherein the second fiber pigtail is aligned by maintaining an angular alignment of the optical component with respect to the second collimator lens while moving the second fiber pigtail along a direction substantially parallel to the optical axis of the second collimator lens for beam focus and moving the second fiber pigtail along a direction substantially perpendicular to an optical axis of the second collimator lens.

15. The method of claim 13 wherein the second collimator lens is a GRIN lens, the method further comprising polishing a portion of a surface of the second fiber pigtail or the GRIN lens at a wedge angle sufficient to refract an optical signal such that the signal follows a path in the second fiber pigtail that is substantially parallel to an optical axis of a receiving fiber of the second fiber pigtail.

16. The method of claim 15 wherein a surface of the second fiber pigtail is polished at a wedge angle of about 8° and a surface of the GRIN lens is polished at a wedge angle of between about 5.0° and about 5.4°.

17. The method of claim 15 wherein a surface of the GRIN lens is polished at a wedge angle of about 8° and a surface of the second fiber pigtail is polished at a wedge angle of between about 11.1° and about 11.5°.

18. The method of claim 1 further comprising:
disposing a second collimator lens proximate the optical component such that the optical component is disposed between the first and second collimator lenses and;
passively aligning the optical component at an angular orientation with respect to the focal plane of the second collimator lens.

19. The method of claim 18 wherein the distance between the optical component and the second collimator lens is such that the reflecting portion of the optical component is disposed on a focal plane of the second collimator lens

20. The method of claim 19 wherein disposing the second collimator lens proximate the optical component includes engaging a first surface of an optical component to a first end of a first spacer and engaging the first collimator lens to a second end of the first spacer, wherein the second spacer has a length selected such that, when the second spacer engages the optical component and the second collimator lens, the first surface of the optical component is disposed on the focal plane of the second collimator lens.

21. The method of claim 18 wherein the passively aligning the reflecting portion includes aligning the reflecting portion of the optical component within a tolerance of about ±1.0° with respect to the optical axis that is substantially perpendicular to the focal plane of the second collimator lens.

22. The method of claim 18 wherein the second collimator lens includes at least one convex surface.

23. The method of claim 22 wherein the first collimator lens is a GRIN lens.

24. The method of claim 18 wherein the second collimator lens is a GRIN lens.

25. The method of claim 24 wherein the first collimator lens includes at least one convex surface.

26. The method of claim 18 further comprising:
aligning a fiber pigtail to the optical component;
fixing a position of the optical component with respect to the second collimator lens while moving the fiber pigtail along a direction substantially perpendicular to an optical axis of the collimator lens and moving the pigtail along a direction substantially parallel to the optical axis of the collimator lens.

27. The method of claim 26, further comprising fixing a position of the fiber pigtail with respect to the second collimator lens.

28. The method of claim 27 wherein the second collimator lens is a GRIN lens.

29. The method of claim 28 further comprising polishing at least a portion of a surface of the GRIN lens or the fiber pigtail at a wedge angle sufficient to refract an optical signal parallel to an optical axis of a receiving fiber.

30. The method of claim 29 wherein a surface of the second fiber pigtail is polished at a wedge angle of about 8° and a surface of the GRIN lens is polished at a wedge angle of between about 5.0° and about 5.4°.

31. The method of claim 29 wherein a surface of the GRIN lens is polished at a wedge angle of about 8° and a surface of the second fiber pigtail is polished at a wedge angle of between about 11.1°and about 11.5°.

32. The method of claim 1, wherein the reflecting portion of the optical component includes a filter.

33. The method of claim 32, wherein the filter transmits optical signals having wavelengths in a certain band or bands and reflects optical signals having other wavelengths.

34. The method of claim 33, wherein the optical component is a wavelength division multiplexing (WDM) filter or an optical add/drop module (OADM) filter.

35. An optical apparatus comprising:
an optical component, having a reflecting portion;
a first collimator lens;
a first spacer, disposed between the optical component and the first collimator lens, the first spacer having a length selected such that, when the first spacer engages the optical component and the first collimator lens, the reflecting portion of the optical component is disposed on a focal plane of the first collimator lens,
wherein the reflecting portion of the optical component is configured to reflect at least a portion of an optical signal from a launch fiber back towards a receiving fiber that is disposed on the same side of the optical component as the launch fiber,
wherein the first spacer is configured to passively align the optical component at an angular orientation with respect to a focal plane of the first collimator lens.

36. The optical apparatus of claim 35, further comprising a holding tube configured to receive the optical component, the first spacer and the first collimator lens.

37. The optical apparatus of claim 35 wherein the first spacer, and holding tube are configured to align the first surface of the optical component to within an angular tolerance of about ±1.0° with respect to an optical axis that is substantially perpendicular to the focal planes of the first collimator lens.

38. The optical apparatus of claim 37 wherein the reflecting portion of the optical component includes a filter.

39. The optical apparatus of claim 38 wherein the filter transmits optical signals having wavelengths in a certain band or bands and reflects optical signals having other wavelengths.

40. The optical apparatus of claim 39 wherein the optical component is a wavelength division multiplexing (WDM) filter or an optical add/drop module (OADM) filter.

41. The optical apparatus of claim 35 wherein the first collimator lens includes at least one convex surface.

42. The optical apparatus of claim 35, further comprising a fiber pigtail optically aligned with the optical component, wherein the first collimator lens is disposed between the optical component and the first fiber pigtail, wherein the fiber pigtail includes the launch fiber and the receiving fiber, wherein the fiber pigtail is in a fixed position relative to the first collimator lens.

43. The optical apparatus of claim 35, further comprising:
a second collimator lens,
wherein the optical component is disposed between the first and second collimator lenses.

44. The apparatus of claim 43, further comprising:
a second spacer disposed between the optical component and the second collimator lens, the second spacer having a length selected such that, when the second spacer engages optical component and the second collimator lens, the reflecting portion of the optical component is disposed on a focal plane of the second collimator lens,
wherein the optical component is disposed between the first and second spacers,
wherein the second spacer is configured to passively align the optical component at an angular orientation with respect to the focal plane of the second collimator lens

45. The optical apparatus of claim 44 further comprising a holding tube configured to receive the optical component, the first spacer, the first collimator lens and the second collimator lens.

46. The optical apparatus of claim 45, further comprising a fiber pigtail optically aligned with the optical component, wherein the second collimator lens is disposed between the optical component and the fiber pigtail, wherein the fiber pigtail is in a fixed position relative to the second collimator lens.

47. The optical apparatus of claim 46, wherein the second collimator lens is a GRIN lens,
wherein a surface of the GRIN lens or the fiber pigtail has been polished at a wedge angle sufficient to refract an optical signal traveling between the GRIN lens and the fiber pigtail such that the signal follows a path in the fiber pigtail that is substantially parallel to an optical axis of a receiving fiber of the fiber pigtail.

48. The optical apparatus of claim 47 wherein a surface of the GRIN lens has a wedge angle of about 8° and a surface of the fiber pigtail has a wedge angle of between about 11.1° and about 11.5°.

49. The optical apparatus of claim 43 wherein a surface of the fiber pigtail has a wedge angle of about 8° and a surface of the GRIN lens has a wedge angle of between about 5.2° and about 5.4°.

50. The optical apparatus of claim 43, wherein one or more of the first and second collimator lenses includes at least one convex surface.

51. The optical apparatus of claim 50, wherein the first collimator lens includes at least one convex surface and the second collimator lens is a GRIN lens.

52. The optical apparatus of claim 50, wherein each of the first and second collimator lenses includes at least one convex surface.

53. An optical apparatus comprising:
a first collimating lens;
a second collimating lens;
an optical component; and
a unitary holding tube,
wherein
the optical component is disposed between the first and second collimating lenses,
a surface of the optical component is disposed on a focal plane of the first collimating lens,
the second collimating lens is a GRIN lens, and
the first and second collimating lenses and the optical component are disposed within the unitary holding tube.

54. The optical apparatus of claim 53, further comprising a fiber pigtail optically coupled to the first collimator lens,
wherein the first collimator lens is disposed between the fiber pigtail and the optical component.

55. The optical apparatus of claim 53, further comprising a fiber pigtail optically coupled to the second collimator lens,
wherein the second collimator lens is disposed between the fiber pigtail and the optical component
wherein the fiber pigtail is in a fixed position relative to the second collimator lens.

56. The optical apparatus of claim 55, wherein a surface of the GRIN lens or the fiber pigtail has been polished at a wedge angle sufficient to refract an optical signal traveling between the GRIN lens and the fiber pigtail such that the signal follows a path in the fiber pigtail that is substantially parallel to an optical axis of a receiving fiber of the fiber pigtail.

57. The optical apparatus of claim 56 wherein a surface of the GRIN lens has a wedge angle of about 8° and a surface of the fiber pigtail has a wedge angle of between about 11.1° and about 11.5°.

58. The optical apparatus of claim 56 wherein a surface of the fiber pigtail has a wedge angle of about 8° and a surface of the GRIN lens has a wedge angle of between about 5.2° and about 5.4°.

59. The optical apparatus of claim 56 wherein a surface of one or more of the GRIN lens and the fiber pigtail includes a portion that is substantially parallel to an end face of the holding tube.

60. The optical apparatus of claim 53, further comprising a fiber pigtail optically coupled to the first collimator lens,
wherein the first collimator lens is disposed between the fiber pigtail and the optical component
wherein the fiber pigtail is in a fixed position relative to the first collimator lens.

61. The optical apparatus of claim 53, wherein the first collimating lens is a GRIN lens.

62. The optical apparatus of claim 53, wherein the first collimating lens has at least one convex surface.

63. The optical apparatus of claim 62, further comprising a spacer engaged between the first collimating lens and the optical component.

64. An optical apparatus comprising:
a filter, having a reflecting portion;
a first collimator lens having a convex surface;
a first spacer, disposed between the filter and the first collimator lens, the first spacer having a length selected such that, when the first spacer engages a first surface of the filter and the convex surface of the first collimator lens, the first surface of the filter is disposed on a focal plane of the first collimator lens;
a second collimator lens having a convex surface; and
a second spacer disposed between the filter and the second collimator lens, the second spacer having a length selected such that, when the second spacer engages a second surface of the filter and the convex surface of the second collimator lens, the first surface of the filter is disposed on a focal plane of the second collimator lens;
wherein the filter is disposed between the first and second spacers,
wherein the filter is disposed between the first and second collimator lenses,
wherein the reflecting portion of the filter is configured to reflect at least a portion of an optical signal from a launch fiber back towards a receiving fiber that is disposed on the same side of the optical component as the launch fiber.
wherein the first spacer is configured to passively align the reflecting portion of the filter at an angular orientation with respect to an optical axis that is substantially perpendicular to the focal plane of the first collimator lens; and
wherein the second spacer is configured to passively align the reflecting portion of the filter at an angular orientation with respect to that is substantially perpendicular to the focal plane of the second collimator lens.

65. The apparatus of claim 64 wherein the reflecting portion of the filter transmits optical signals having wavelengths in a certain band or bands and reflects optical signals having other wavelengths.

66. The apparatus of claim 64 wherein the reflecting portion of the filter includes a thin filter film disposed on a surface of a light transmitting substrate.

67. An optical device, comprising:
means for positioning an optical component proximate a collimator lens such that a reflecting portion of the optical component is disposed on a focal plane of the first collimator lens; and
means for passively aligning the optical component at an angular orientation with respect to a focal plane of the first collimator lens,
wherein the reflecting portion of the optical component is configured to reflect at least a portion of an optical signal from a launch fiber back towards a receiving fiber that is disposed on the same side of the optical component as the launch fiber.
